(19) United States
(12) Patent Application Publication
(10) Pub. No.: US 2011/0163686 A1
(43) Pub. Date: Jul. 7, 2011

(54) LIGHTING DEVICE

(76) Inventors: Tsutomu Ichihara, Osaka (JP); Takashi Hatai, Osaka (JP)

(21) Appl. No.: 13/002,851

(22) PCT Filed: Jul. 8, 2009
(86) PCT No.: PCT/JP2009/062450

§ 371 Date: Feb. 9, 2011

(30) Foreign Application Priority Data
Jul. 9, 2008 (JP) 2008-179413

(51) Int. Cl. H05B 37/02

(52) U.S. Cl. 315/291

(57) ABSTRACT

A lighting device comprising a hermetically sealed vessel having a light transmissive property, a gas filled in the hermetically sealed vessel and configured to emit a first light having wavelength when excited by electron, the wavelength of the first light has a range from vacuum ultraviolet to visual light, an electron source disposed within the hermetically sealed vessel, the electron source configured to emit the electron when an operation voltage is applied, anode electrode disposed within the hermetically sealed vessel, a phosphor configured to emit the second light when excited by the first light. The electron source is configured to emit the electron having energy distribution when the electron source receives the emission voltage. The energy distribution having a peak energy. The peak energy is higher than an excitation energy of the gas. The peak energy is lower than an ionization energy of the gas.

### TECHNICAL FIELD

This invention relates to lighting devices. Particularly, this invention relates to a lighting device being configured to excite gas in a hermetically sealed vessel to emit exciting light which is defined as a first light, to convert the first light into second light having wavelength which is different from wavelength of the first light, and to emit the second light.

### BACKGROUND ART

Traditionally, a fluorescent lamp using mercury is used. However, according to escalation of the interest of the environmental problem of the earth, a number of researches of the lighting device using no mercury are made. The lighting device using no mercury is, so called, a mercury free fluorescent lamp. The mercury free fluorescent lamp comprises a hermetically sealed vessel and noble gas. The hermetically sealed vessel has a light transmissive property. The noble gas is filled in the hermetically sealed vessel. The noble gas is exemplified by xenon gas.

However, the fluorescent lamp with the noble gas is configured to emit the light with efficiency which is lower than the efficiency of the light of the prior fluorescent lamp with the mercury. Therefore, there is a need to apply a high starting voltage and a high operation voltage to a pair of the electrodes in the hermetically sealed vessel in order to emit the light with the efficiency which is equal to the efficiency of the prior fluorescent lamp.

Japanese patent application publication No. 2002-150944A discloses a lighting device having a type which is other than the above. The lighting device comprises a hermetically sealed vessel, a noble gas, a pair of discharge electrodes, an electron source, and a phosphor layer. The hermetically sealed vessel has a light transmissive property. The noble gas is exemplified by such as xenon gas. The noble gas is filled in the hermetically sealed vessel. The electron source is a field emission type electron source. The phosphor layer is disposed on an inside surface of the hermetically sealed vessel. The hermetically sealed vessel houses a pair of the discharge electrodes and the electron source. The electron source is provided with a pair of operating electrodes. The lighting device is configured to operate the electron source, whereby the electron source emits electron. Subsequently, the voltage is applied between the discharge electrodes. The lighting device with this configuration is configured to emit the first light by the starting voltage which is about half of the starting voltage which is required for the prior lighting device. The phosphor layer is configured to convert the first light into the second light. The second light has a wavelength which is longer than a wavelength of the first light.

### DISCLOSURE OF THE INVENTION

### Problem to be Resolved by the Invention

In order to emit the light from the lighting device, there is a need to supply the electron having ionization energy which is equal to or higher than 12.13 eV to the xenon gas in the hermetically sealed vessel. The energy of 12.13 eV is equivalent to the ionization energy of the xenon gas. The ionization energy for ionize the xenon gas is greater than the exciting energy, 8.44 eV, for generating ultraviolet light from the xenon gas. Therefore, a high voltage is applied between the operating electrodes of the electron source. Therefore, the above lighting device is not able to reduce a consumption of the electrical power. Therefore, it is impossible to improve the lighting efficiency per unit of input electrical power. The high voltage applied between the operation voltages causes a short life of the electron source.

In addition, in the above lighting device, the discharge plasma causes the ion. The ion caused by the discharge plasma collides with the electron source and the fluorescent layer. That is, the collision of the ion with the electron source and the fluorescent layer damages the electron source and the fluorescent layer. The collision of the ion with the electron source and the fluorescent layer causes the short life of the electron source and the fluorescent layer.

This invention is achieved to solve the above problem. An object of this invention is to produce the lighting device which is operated by low consumption of the electrical power, which has a high efficiency, and which has a long life.

### Means of Solving the Problem

In order to solve the above problem, the lighting device in this invention comprises a hermetically sealed vessel, gas, an electron source, an anode electrode, a control unit, and a phosphor. The hermetically sealed vessel has a light transmissive property. The gas is filled in said hermetically sealed vessel. The gas is configured to emit a first light having wavelength when said gas is excited by electron. The wavelength of the first light has a range from vacuum ultraviolet to visual light. The electron source is disposed within the hermetically sealed vessel. The electron source has a first operation electrode and a second operation electrode. The electron source is configured to emit the electron when an operation voltage is applied between the first operation electrode and the second operation electrode. The anode electrode is disposed within the hermetically sealed vessel. The anode electrode is faced to the electron source. The control unit is configured to apply the operation voltage between the first operation electrode and the second operation electrode. The control unit is configured to apply an emission voltage between the electron source and the anode electrode such that the electron is moved toward said anode electrode. The phosphor is disposed within the hermetically sealed vessel. When said phosphor being excited by the first light, the phosphor is configured to emit a second light having wavelength. The wavelength of the second light is different from the wavelength of the first light. When said electron source receives the emission voltage, the electron source is configured to emit the electron having energy distribution. The energy distribution has a peak energy. The peak energy is greater than an excitation energy of the gas. The peak energy is lower than an ionization energy of the gas.

In this case, the control unit is configured to regulate the voltage which is applied between the operation electrodes. Consequently, the control unit allows the electron source to emit the electron having the energy distribution with peak value. The peak value is greater than the excitation energy of the gas. The peak value is lower than the ionization energy of the gas. Consequently, the control unit is configured to excite the gas without discharge of the gas. The gas which is excited emits the exciting light which is defined as the first light. The phosphor is irradiated with the first light which is emitted from the gas. Consequently, the phosphor converts the first light into the second light which has the wavelength which is different from the wavelength of the first light. The second light is emitted from the hermetically sealed vessel. Therefore, it is possible for the lighting device to emit the light by applying the low voltage between the operation electrodes, compared with a case where the light is emitted from the phosphor by discharging the gas. Therefore, it is possible to obtain the lighting device having the high luminescent efficiency with low consumption of the electrical power. In addition, there is no possibility that the ion of the discharge plasma damages the electron source and the phosphor layer. Therefore, it is possible to obtain the lighting device having long operation life.

It is preferred that the gas is filled in the hermetically sealed vessel such that the gas has gas pressure of equal to more than 2 kPa to equal to or less than 20 kPa.

In this case, it is possible to prevent the gas from being discharged. Furthermore, it is possible to improve the luminescent efficiency of the lighting device.

It is preferred that the gas is a noble gas. The gas is filled in the hermetically sealed vessel to have a predetermined gas pressure. The predetermined gas pressure is set to form an excimer when the gas is excited.

In this case, it is possible to develop the excimer. (The excimer is molecule having excitation state.) In addition, in this case, it is possible to reduce the loss of the Stokes in the phosphor. Consequently, it is possible to obtain the high luminescent efficiency of the lighting device.

It is preferred that the control unit is configured to apply the operation voltage which is a rectangular wave to the electron source. Consequently, the control unit provides the electron source with an on-state and off-state alternately. The electron source is configured to emit the electron over an on-period when said electron source has the on-state. The electron source is prohibited from emitting the electron over an off-period when the electron source has the off-state.

In this case, the control unit is configured to operate the electron source intermittently. Therefore, this configuration makes it possible to operate the lighting device with low electrical power, compared with the case where the electron source is operated continuously.

The gas has a property of making an afterglow over an afterglow period. The afterglow period is started from a time when a state of the electron source is shifted from the on-state to the off-state. The off period is set to be shorter than the afterglow period.

In this case, the lighting device is configured to emit the light even if the electron source stops supplying the electron in a predetermined period. Therefore, this configuration makes it possible to improve the luminescent efficiency of the lighting device.

It is preferred that the electron source is a Ballistic Electron Surface Emitting type electron source. The Ballistic Electron Surface Emitting type electron source comprises a lower electrode, a surface electrode, and a strong electric field drift layer. The surface electrode is disposed in an opposed relation to said lower electrode. The surface electrode defines the first operation electrode. The lower electrode defines the second operation electrode. The strong electric field drift layer is disposed between the surface electrode and the lower electrode. The strong electric field drift layer comprises a plurality of semiconductor fine crystals and a plurality of electrically insulation layers. The semiconductor fine crystals have sizes of nanometer orders. Each the electrically insulation layer is formed on a surface of said semiconductor fine crystal. Each the electrically insulation layer has a thickness which is smaller than a grain size of the semiconductor fine crystal. The control device is configured to apply the operation voltage which is the rectangular wave voltage and which is alternating voltage to said electron source.

In this case, a first period and a second period are provided to the electron source. In the first period, the control unit is configured to apply the forward bias voltage between the operation electrodes. Consequently, the electron source supplies the electron to the inside of the hermetically sealed vessel. When the forward bias voltage is applied between the operation electrodes, the electron is caught by the trap in the strong electric field drift layer. Subsequently, in the second period, the control unit is configured to apply the reverse bias voltage between the operation electrodes. Consequently, the electron which is caught by the trap in the strong electric field drift layer is emitted to the lower electrode. In this manner, the first period and the second period is provided to the electron source. Consequently, it is possible to prevent the loosening of the electrical field due to the electron which is caught by the trap in the strong electric field drift layer. Therefore, it is possible to achieve the long operation time of the electron source.

It is preferred that the control unit is configured to apply the emission voltage having the rectangular wave to the anode electrode and the electron source. The emission voltage having the rectangular wave is in synchronization with the operation voltage.

This configuration makes it possible for the lighting device to be operated with low consumption of the electrical power, compared with a case where a constant voltage is applied between the anode electrode and the electron source.

It is preferred that the control unit is configured to apply the emission voltage between the anode electrode and the electron source such that the anode electrode has the electrical potential which is higher than the electrical potential of the electron source. According to this configuration, the voltage value of the emission voltage in the off period is set to be lower than the voltage value of the emission voltage in the on period.

In this case, it is possible to operate the electron source with low consumption of the electrical power. Furthermore, in the off period, this configuration makes it possible to pull out the electron to the anode electrode.

In addition, it is preferred that the electron source is spaced from said anode electrode by an interval. The interval is set to be greater than a Paschen minimum.

In this case, it is possible to prevent the discharge of the gas.

### BRIEF EXPLANATION OF THE DRAWINGS

FIG. 1 shows a schematic configuration diagram of the lighting device in the embodiment.

FIG. 2 shows a explanation diagram of a main section of the electron source which is used in the above lighting device.

FIG. 3A to FIG. 3C show explanation diagrams of the property of the above.

FIG. 4 shows explanation diagram of the property of the above.

FIG. 5 shows an explanation diagram of the operation of the above.

FIG. 6 shows an explanation diagram of the property of the above.

FIG. 7 shows an explanation diagram of the operation of the above.

### BEST MODE FOR CARRYING OUT THE INVENTION

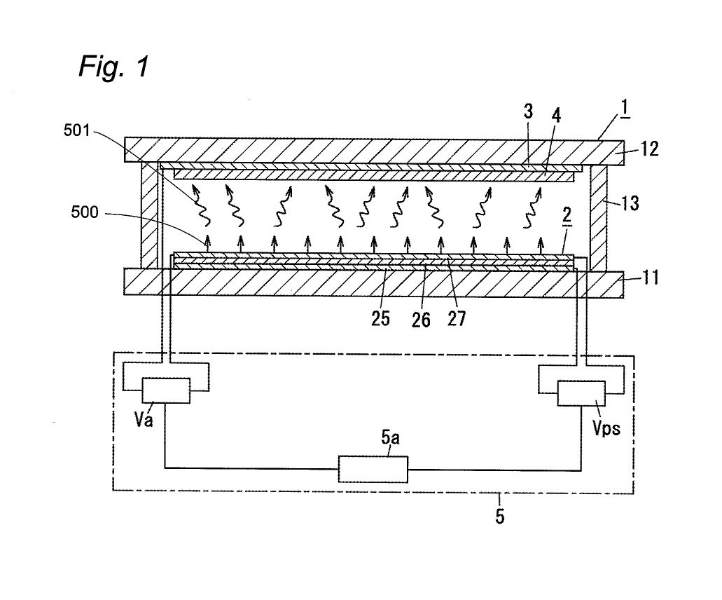

The explanation of the lighting device of the embodiment in this invention is made with attached drawings. FIG. 1 shows a schematic diagram of the lighting device in this embodiment. The lighting device in this embodiment comprises a hermetically sealed vessel 1, an electron source 2, an anode electrode 3, a phosphor layer 4, and a control unit 5. The hermetically sealed vessel 1 has a light transmissive property. The hermetically sealed vessel 1 has air tightness. The hermetically sealed vessel 1 is filled with the gas. When the gas is excited, the gas emits an exciting light. The exciting light is defined as a first light. The exciting light has wavelength which has a range between vacuum ultraviolet and visual light. The gas is exemplified by xenon gas. When the operation voltage is applied between the surface electrode 27 of the electron source 2 and the lower electrode 25 of the electron source 25, the electron source provides the electron to the inside of the hermetically sealed vessel. The electron is provided for exciting the gas. The anode electrode 3 is made of ITO, whereby the anode electrode 3 is a transparent electrode. The anode electrode 3 is disposed such that the anode electrode 3 is faced to the electron source 2. The fluorescent layer 4 is configured to convert the first light into a second light. The second light has a wavelength which is longer than the wavelength of the first light. The second light is a visible light. The second light is emitted to the outside of the hermetically sealed vessel which has a light transmissive property. The control unit 5 is configured to apply the voltage between “the surface electrode 27 of the electron source 2” and “the lower electrode 25 of the electron source 2”. In addition, the control unit 5 is configured to regulate the voltage which is applied between “the surface electrode 27 of the electron source 2” and “the anode electrode 3”. The control unit 5 is configured to apply the voltage between the anode electrode 3 and the surface electrode 27 of the electron source 2. In addition, the control unit 5 is configured to regulate the voltage applied between “the anode electrode 3” and “the surface electrode 27 of the electron source 2”. It is noted that the surface electrode 27 is cooperative with the lower electrode 25 to define the operating electrodes. The surface electrode 27 defines the first operating electrode. The lower electrode 25 defines the second operating electrode.

The hermetically sealed vessel 1 comprises a rear plate 11, a face plate 12, and a spacer 13. The rear plate 11 is made of material having a light transmissive property. The material of the rear plate 11 is exemplified by glass. The rear plate 11 is shaped to have a rectangular plate shape. The face plate 12 is made of material having a light transmissive property. The material of the face plate 12 is exemplified by glass. The face plate 12 is disposed such that the face plate 12 is faced to one surface of the rear plate 11. The face plate 12 is shaped to have a rectangular plate shape. The spacer 13 is interposed between the rear plate 11 and the face plate 12. The spacer 13 is shaped to have a rectangular frame shape. The rear plate 11 is provided with a first surface which is faced with the face plate 12. The first surface of the rear plate 11 mounts the electron source 2. The face plate 12 is provided with a first surface which is faced to the rear plate 11. The first surface of the face plate mounts the anode electrode. The anode electrode 3 is provided with a first surface which is faced to the rear plate 11. The first surface of the anode electrode 3 is provided with the phosphor layer 4. It goes without saying that the hermetically sealed vessel 1 is not limited its shape to the above explained shape. In addition, the materials of the rear plate 11, the face plate 12, and the spacer 13 are not limited to the above explained materials. That is to say, it is possible to employ the material such as the ceramic having the light transmissive property as the material of the rear plate 11, the face plate 12, and the spacer 13. In addition, in this embodiment, an entire of the hermetically sealed vessel 1 is made of material having the light transmissive property. However, there is no need to make the entire of the hermetically sealed vessel 1 by the material having the light transmissive property. That is, it is only required to make at least one portion of the hermetically sealed vessel 1 is made of the material having the light transmissive property.

The electron source 2 is realized by a Ballistic Electron Surface Emitting type electron source (BSD). The Ballistic Electron Surface Emitting type electron source comprises a lower electrode 25, the surface electrode 27, and a strong electric field drift layer 26. The strong electric field drift layer 26 is interposed between the lower electrode 25 and the surface electrode 27. The lower electrode 25 is realized by a metal film which is made of material such as tungsten. The surface electrode 27 is realized by electrically conductive thin film which is made of material such as Au. The surface electrode 27 has a thickness of about equal to or more than 10 nm to about equal to or less than 15 nm. However, the material of the lower electrode 25 and the material of the surface electrode 27 are not limited to the above explained materials. In addition, each one of the lower electrode 25 and the surface electrode 27 may have single layer, and also may have a plurality of layers.

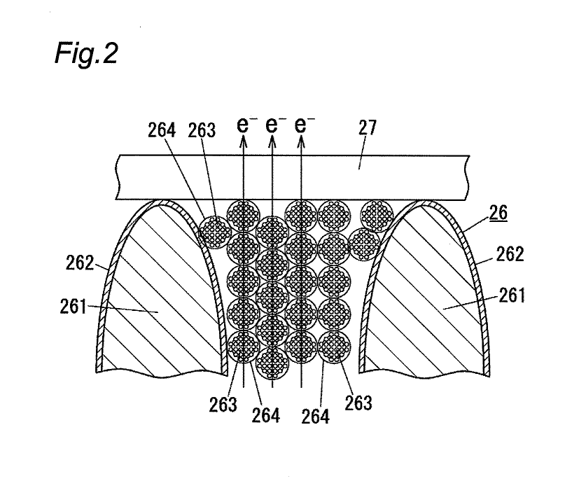

FIG. 2 shows the strong electric field drift layer 26. The strong electric field drift layer 26 comprises a grain (in other words, semiconductor crystal) 261, silicon dioxide film 262, silicon fine crystals 263, and the silicon dioxide film 264. The grain 261, the silicon dioxide film 262, the silicon fine crystal (semiconductor fine crystal) 263, and the silicon dioxide film 264 are located between the lower electrode 25 and the surface electrode 27. The grain 261 is made of poly crystal silicon. The grain 261 is arranged on the surface of the lower electrode 25 such that each the grain 261 is disposed to have a column structure. The grain 261 is provided at its surface with a thin silicon oxide film 262. A plurality of the silicon fine crystal 263 having sizes of nanometer order are located between the grains 261. Each silicon fine crystal 263 is provided at it surface with a plurality of the silicon dioxide film 264. The silicon dioxide film 264 is an electrically insulation film which has a thickness which is smaller than diameter of the grain of the crystal of the silicon fine crystal 263. Each one of the grains 261 extends in the thickness direction of the lower electrode 25. In other words, each one of the grains 261 extends in the thickness direction of the rear plate 11.

In order to emit the electron from the electron source 2, the control means 5a is configured to control an operation power source Vps. Consequently, the operation power source Vps applies the operation voltage between the surface electrode 27 and the lower electrode 25 such that the surface electrode 27 has an electrical potential which is higher than an electrical potential of the lower electrode. When the operation voltage is applied between the surface electrode 27 and the lower electrode 25, the electron is supplied to the strong electric field drift layer 26 from the lower electrode 25. Subsequently, the electron which is supplied to the strong electric field drift layer 26 is drifted, whereby the electron is emitted through the surface electrode 27.

It is noted that it is possible to allow the electron source 2 to emit the electron when the operating power source Vps applies the low voltage, such as about 10 to 20 voltage, between the surface electrode 27 and the lower electrode 25. Furthermore, a degree of the dependence of the vacuum of the electron discharge property of the electron source 2 in this embodiment is low. In addition, the electron source 2 in this embodiment is configured to stably emit the electron with high efficiency of the emission of the electron without causing popping phenomenon.

The above electron source is configured to emit the electron as explained below. That is to say, the voltage is applied between the surface electrode 27 and the lower electrode 25 such that the surface electrode 27 has an electrical potential which is higher than the lower electrode 25. When the lower electrode 25 receives the voltage, the lower electrode 25 supplies the electron e⁻. A large part of the electrical field which is generated in the strong electric field drift layer 26 is applied to the silicon dioxide film 264. Therefore, the supplied electron e⁻ receives the force which is caused by the strong electrical field which is generated in the silicon dioxide film 264. A direction of the force which is caused by the strong electrical field is indicated by an arrow of FIG. 2 The electron e⁻ which receives the force directing the above mentioned arrow is drifted toward the surface along the direction indicated by the arrow through area between the grains 261 of the strong electric field drift layer. The electron e⁻ which is drifted is passed through the surface electrode 27, whereby the electron e⁻ which is drifted is emitted. In this manner, in the strong electric field drift layer 26, the electron e⁻ which is supplied from the lower electrode 25 is accelerated and drifted by the electric field generated in the silicon dioxide film 264. In this time, the electron e⁻ which is supplied from the lower electrode 25 is hardly scattered. Subsequently, the electron e⁻ is emitted through the surface electrode 27. This is, so called, the Ballistic Electron Surface Emitting phenomenon. In addition, heat generated in the strong electric field drift layer 26 is released through the grain 261. Therefore, the electron source does not cause the popping phenomenon when the electron source emits the electron. Consequently, the electron source stably emits the electron.

In addition, in the above strong electric field drift layer 26, the silicon dioxide film 264 also defines electrically insulation film. The electrically insulation film is formed by oxidation process. However, it is possible to form the electrically insulation film by nitridation process, instead of the oxidation process. According to the nitriation process, the silicon nitride film, defined as the electrically insulation film, is formed, instead of the silicon dioxide film 262 and the silicon dioxide film 264. Furthermore, instead of the oxidation process, oxynitride process may be employed in order to form the electrically insulation film. According to the oxynitride process, the silicon oxynitride film, defined as the electrically insulation film, is formed, instead of the silicon dioxide film 262 and the silicon dioxide film 264. In addition, this embodiment discloses the electron source 2 which is directly disposed on one surface of the rear plate 11 which is made from the glass substrate. However, it is also possible to employ the electron source comprises the silicon substrate and the ohmic electrode disposed on a rear surface of the silicon substrate. The above mentioned electron source is also disposed on the one surface of the rear plate 11.

The above control unit 5 comprises operation power source Vps, a power source Va for anode electrode, and a control means 5a. The operation power source Vps is configured to apply the voltage between the surface electrode 27 of the electron source 2 and the lower electrode 25 of the electron source 2. The power source Va for anode electrode is configured to apply the voltage between “the anode electrode 3” and “the surface electrode 27 of the electron source 2”. The control means 5a is realized by the microcomputer. The micro computer is configured to control the operation power source Vps and also the power source Va for anode electrode. The control means 5a is configured to control the operation power source Vps so that the operation power source Vps applies the operation voltage to the electron source 2. Consequently, the electron source 2 emits the electron having the distribution of energy having the peak energy. The control means 5a is configured to control the power source Va for anode electrode such that the power source Va for anode electrode applies the emission voltage between the anode electrode 3 and the electron source 2. The operation voltage and the emission voltage are set such that the peak energy of the distribution of the energy of the electron is higher than excitation energy of the xenon gas in the hermetically sealed vessel 1. In addition, the operation voltage and the emission voltage are set such that the peak energy of the distribution of the energy of the electron is lower than the ionization energy of the xenon gas. That is, the operation voltage is set such that the peak energy of the distribution of the energy of the electron is higher than the excitation energy of the xenon gas. The operation voltage is set such that the peak energy of the distribution of the energy of the electron is lower than the ionization energy of the xenon gas. The control means 5a is configured to control the operation power source Vps in order to regulate the voltage which is applied between the surface electrode 27 and the lower electrode 25. Consequently, the gas is excited without discharge.

In the lighting device of this embodiment, the control unit 5 is configured to control the operation power source Vps. Consequently, the operation power source Vps applies the operation voltage between the surface electrode 27 and the lower electrode 25 such that the surface electrode 27 has the electrical potential which is higher than the electrical potential of the lower electrode 25. In addition, the control unit 5 is configured to control the power source Va for anode electrode. Consequently, the power source Va for anode electrode applies the emission voltage between “the anode electrode” and “the surface electrode 27 of the electron source 2” such that the anode electrode 3 has the electrical potential which is higher than the electrical potential of the surface electrode 27 of the electron source. Therefore, the electron e⁻ which is emitted from the electron source 2 receives the force caused by the electrical field between the anode electrode 3 and the surface electrode 27. When the electron e⁻ receives the force, the electron e⁻ is moved toward the anode electrode 3. Consequently, the electron e⁻ is collided with the xenon atom which is located between the anode electrode 3 and the surface electrode 27.

The electron which is emitted from the electron source 2 receives the energy from the electric field which is generated between the anode electrode 3 and the surface electrode 27. The energy that the electron receives from the electron source2 depends on the product of “the electrical field intensity between the anode electrode 3 and the surface electrode 27” and “the mean free path of the electron in the gas”. The electrical field intensity depends on “the voltage which is applied between the anode electrode 3 and the surface electrode 27” and “the distance between the anode electrode 3 and the surface electrode 27”. “The mean free path of the travel” depends on “the type of the gas in the hermetically sealed vessel 1” and “the gas pressure”. In this embodiment, the gas pressure is set to be 5 kPa. The mean free path of the electron is short. Therefore, when the electron source 2 emits the electron, the energy that the electron receives from the electrical field which is generated between the anode electrode 3 and the surface electrode 27 is smaller than the peak energy of the energy distribution of the electron which is emitted from the electron source. Therefore, the energy distribution of the electron which is emitted from the electron source 2 is slightly shifted toward the high energy side from the energy distribution of the electron which collides with the gas. In addition, the voltage at 20 volts is applied between the surface electrode 27 of the electron source 2 and the lower electrode 25 of the electron source 2. Consequently, the surface electrode 27 has the electrical potential which is higher than the electrical potential of the lower electrode 25. When the voltage at 20 volts is applied between the surface electrode 27 and the lower electrode 25, the electron source emits the electron. This electron has the peak energy of the distribution of the energy. The peak energy of the electron is greater than the exciting energy of the xenon gas. In addition, the peak energy of the electron has the peak energy which is smaller than the ionization energy of the xenon gas. The electron which is emitted from the electron source has the peak energy of the distribution of the energy at 10 eV.

As will be understood from the above explanation, the lighting device in this embodiment comprises the control unit 5 which is configured to apply the voltage between the surface electrode 27 and the lower electrode 25. When the electron source receives the voltage, the electron source emits the electron having the peak energy of the distribution of the energy. The peak energy of the electron is greater than the exciting energy of the gas, and is smaller than the ionization energy of the gas. The electron is indicated by the arrow 500 in FIG. 1. When the electron is emitted, the electron excites the gas in the hermetically sealed vessel 1, without causing the discharge. When the gas is excited, the excited gas emits the exciting light. The exciting light is defined as a first light. The first light is indicated by arrow 501 in FIG. 1. When the first light is emitted, the phosphor layer 4 converts the first light into the second light. The second light has the wavelength which is longer than the first light. The second light is emitted from the phosphor layer 4. In the lighting device with the above configuration, when the low voltage is applied between the surface electrode 27 and the lower electrode 25, the second lighting device emits the second light. Thus, the lighting device with the above configuration is configured to emit the light by the low electrical power, compared with the electrical power which is required for the lighting device being configured to emit the light by discharging the gas. Therefore, this configuration makes it possible to produce the lighting device which consumes low electrical power and which emits the light with the high luminescence efficiency. Furthermore, there is no possibility of that the electron source 2 and the phosphor layer 4 are damaged by the discharge plasma. Therefore, this configuration also makes it possible to provide the lighting device having long operation life.

Under this configuration, it is preferred to make a gap of more than 1 centimeter between the electron source 2 and the anode electrode 3. The gap of more than 1 centimeter corresponds to the Paschen minimum. The configuration that the gap between the electron source 2 and the anode electrode 3 is set to be greater than the Paschen minimum makes it harder for the gas to discharge. It goes without saying that the gap between the electron source 2 and the anode electrode 3 is not limited to 1 centimeter.

In addition, the lighting device in this embodiment comprises the Ballistic Electron Surface-Emitting type electron source as the electron source 2. The Ballistic Electron Surface-Emitting type electron source is capable of stably operating even if the Ballistic Electron Surface Emitting type electron source is disposed in the gas. In addition, the Ballistic Electron Surface Emitting type electron source is configured to emit the electron having the initial energy of more than 8.44 eV which corresponds to the exciting energy of the xenon gas. That is to say, the initial energy of the electron which is emitted from the Ballistic Electron Surface Emitting type electron source is higher than the initial energy of the electron which is emitted from the spindt type electron source which acts as the electron source. Therefore, the lighting device which comprising the Ballistic Electron Surface Emitting type electron source as the electron source is configured to be operated with the low voltage, compared with the lighting device which comprise the spindt type electron source which acts as the electron source. Consequently, it is possible to obtain the lighting device which consumes the low electrical power.

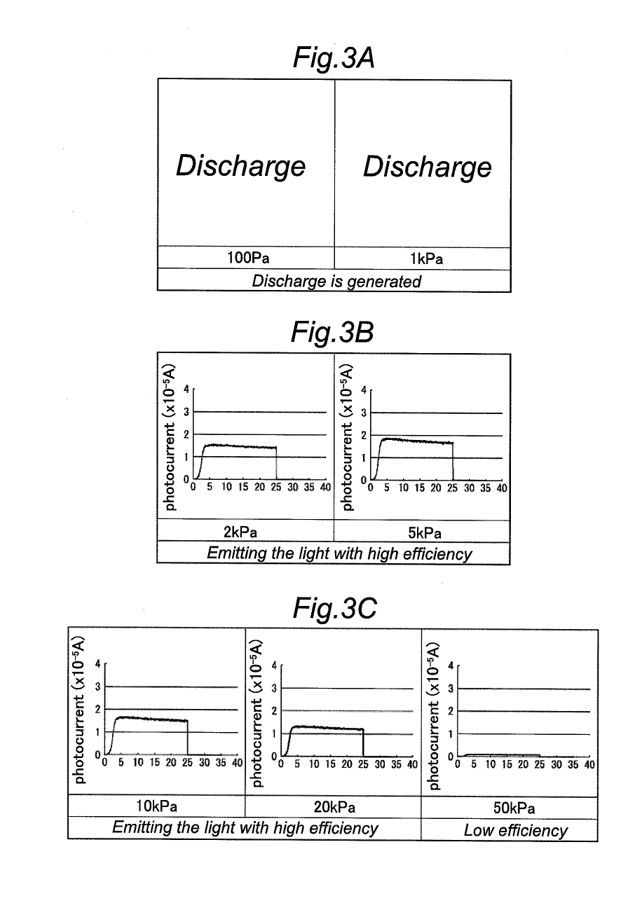

By the way, the lighting device in this embodiment, the hermetically sealed vessel 1 is filled with the xenon gas. The xenon gas is set to have gas pressure of 5 kPa. However, the gas pressure of the xenon gas is not limited to 5 kPa. FIG. 3A to FIG. 3C shows the emission intensities of the ultraviolet light which is emitted from the lighting device which is filled with xenon gases having various gas pressures. The emission intensities are measured by the photomultiplier. In this experiment, the lighting device comprises the hermetically sealed vessel 1, the gas, the electron source 2, the anode electrode 3, and the control unit 5. In other words, the lighting device in this experiment comprises no phosphor layer 4. In this lighting device, the control unit 5 is configured to apply the voltage at 100 volts between the anode electrode 3 and the surface electrode 27. In addition, the control unit 5 applies the pulse voltage at 20 volts between the surface electrode 27 and the lower electrode 25 such that the surface electrode 27 has the electrical potential which is higher than the electrical potential of the lower electrode 25. As will be understood from FIG. 3B and FIG. 3C, the hermetically sealed vessel is filled with the gasses having the xenon gas pressures of 2 kPa to 20 kPa. In these cases, it is possible to prevent the discharge of the xenon gas. In addition, it is possible to improve the luminescent efficiency. In contrast, the discharge is caused in the hermetically sealed vessel which is filled with gas having the gas pressure of 100 Pa and 1 kPa. Therefore, the measurement by the photomultiplier is not performed.

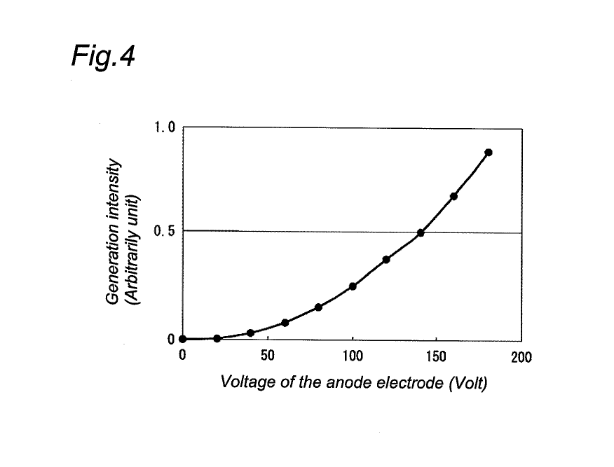

In contrast, FIG. 4 shows another example of the measurement result of the emission intensity of the ultraviolet light by the photomultiplier. In FIG. 4, the anode electrode 3 is spaced from the surface electrode 27 by 1 cm. The xenon gas is filled in the hermetically sealed vessel 1 such that the xenon gas has the gas pressure of 5 kPa. When the anode electrode has voltage of 0 volt to 180 volts, the discharge is not caused. That is, it is possible to prevent the discharge by setting the conversion electrical field of 0 to 3.6 V/mPa. The conversion electrical field is defined as “E/P” by the following formula. “E: electrical field intensity developed between “the anode electrode 3” and “the surface electrode 27 of the electron source 2” p: gas pressure (Pa)” In addition, FIG. 4 shows the increase of the emission intensity of the ultraviolet light according to the increase of the voltage of the anode electrode. When the voltage of the anode electrode is increased, the peak energy of the distribution of the energy of the electron is shifted to the high energy side. According to this, the increase of the probability of the excitation of the xenon gas is caused. It is presumed that the increase of the emission intensity of the ultraviolet light is caused by the increase of the probability of the excitation of the xenon gas.

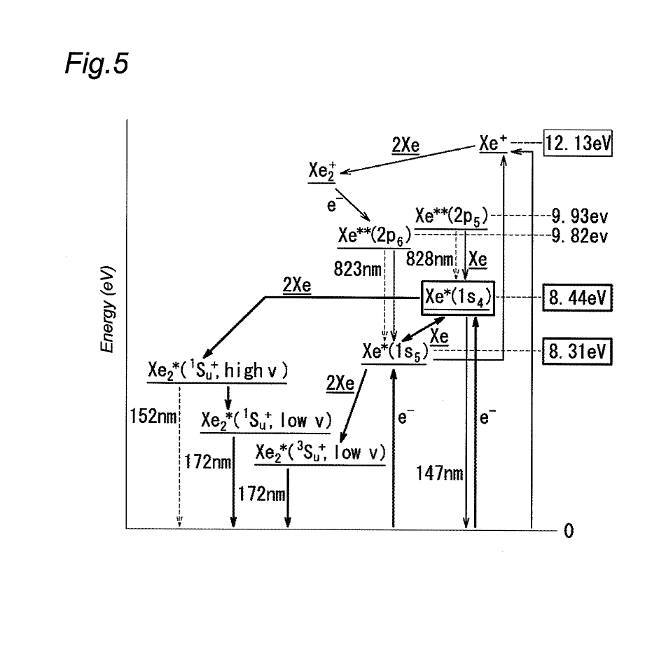

In addition, as shown in FIG. 5, it is required to supply the energy of 12.13 eV to the xenon atom in order to ionize and discharge. In contrast, in order to excite the xenon atom and emit the ultraviolet light having the wavelength of 147 nm from the xenon atom, it is only required to supply the exciting energy of 8.44 eV. In addition, the excimer which is defined by the xenon atom having the excitation state is produced, the light having the wavelength of 172 nm which is longer than the wavelength of 147 nm is emitted. It is noted that the numerical value of the down pointing arrow indicates the light emission wavelength.

In addition, in this embodiment, the xenon gas, a type of noble gas, is used as the gas. In addition, the hermetically sealed vessel 1 is filled with the gas having the gas pressure of 5 kPa such that the gas is capable of developing the excimer. Therefore, when the electron source 2 supplies the electron to the inside of the hermetically sealed vessel, the excimer is developed in the hermetically sealed vessel. (The excimer is the molecule having the excitation state.) That is to say, it is possible to decrease the loss of the Stokes by the phosphor of the phosphor layer 4. Consequently, it is possible to obtain the lighting device with improvement of the light emission efficiency.

In addition, the control means 5a of this embodiment is configured to send the control signal to the operation power source Vps. When the operation power source Vps receives the control signal, the operation power source Vps applies the operation voltage having the rectangular wave between the surface electrode 27 and the lower electrode 25. Consequently, the surface electrode 27 has the electrical potential which is higher than the electrical potential of the lower electrode 25. That is, when the operation power source Vps receives the control signal, the operation power source Vps applies the operation voltage having the rectangular wave to the electron source 2. Consequently, the operation power source Vps gives the on-state and the off-state to the electron source 2 alternately. The electron source 2 is configured to supply the electron to the inside of the hermetically sealed vessel 1 when the operation power source Vps provides the electron source with the on-state. The operation power source Vps is configured to provide the electron source with the off-state so that the operation power source Vps prohibits the electron source 2 from supplying the electron to the inside of the hermetically sealed vessel 1. Therefore, when the electron source 2 receives the operation voltage having the rectangular wave, the electron source 2 supplies the electron to the hermetically sealed vessel 1 periodically. In this manner, the control unit 5 applies the rectangular wave voltage between the surface electrode 27 and the lower electrode 25 such that the surface electrode 27 has the electrical potential which is higher than the electrical potential of the lower electrode 25. As a result, the electron source 2 supplies the electron to the inside of the hermetically sealed vessel 1, periodically. Consequently, in the lighting device of this embodiment, the control unit 5 is configured to operate the electron source 2 periodically. Therefore, this configuration makes it possible to operate the lighting device with low consumption of the electrical power, compared with the lighting device comprising the control unit being configured to operate the electron source 2 continuously.

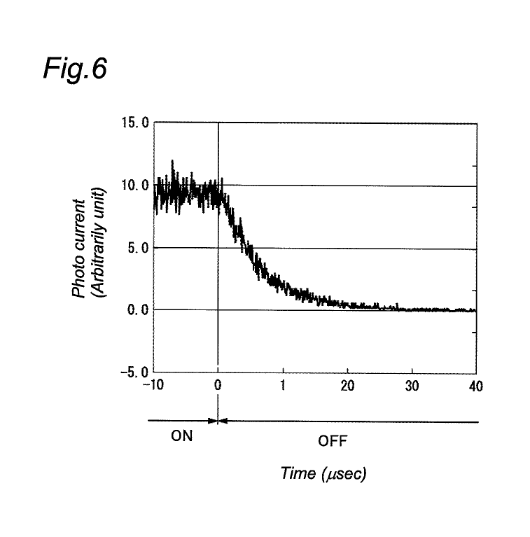

FIG. 6 shows the measurement result of the time-dependent change of the ultraviolet light which is emitted from the lighting device. This measurement is made with using the lighting device which comprising the hermetically sealed vessel 1, the xenon gas, the electron source 2, the anode electrode 3, the control unit 5. That is, the lighting device comprises no phosphor layer 4. In addition, the control unit 5 is configured to apply the pulse voltage at 20 volts between the surface electrode 27 and the lower electrode 25 such that the surface electrode 27 has the electrical potential which is higher than the electrical potential of the lower electrode 25. In FIG. 6, “ON” indicates the on-period where the electron source 2 receives the pulse voltage. In FIG. 6, “OFF” indicates the off-period where the electron source 2 receives no pulse voltage. As will be understood from FIG. 6, the afterglow is caused over 20 microseconds after the time when the impression of the pulse voltage to the electron source 2 is stopped. That is to say, period of afterglow is recognized as 20 microseconds.

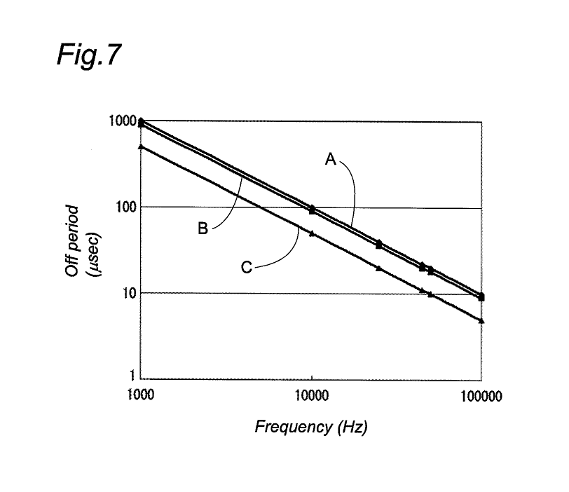

Therefore, in the rectangular wave which is output from the control unit 5, the predetermined period of the off state of the electron source is set to be shorter than the period of the afterglow. FIG. 7 shows the off-period in a case where “the frequency of the above rectangular wave voltage” and “period of the off in the duty cycle” are varied. (That is, off period) In FIG. 7, abscissa axis indicates the frequency. The ordinate axis indicates the off period. “A” shows the relationship between the frequency and the off period in a case where the on term of the duty cycle is set to be 1 percent. “B” indicates the relationship between the frequency and the off period in a case where the on term of the duty cycle is set to be 10 percents. “C” indicates the relationship between the frequency and the off period in a case where the on term of the duty cycle is set to be 50 percents.

As will be understood from FIG. 7, in the lighting device of this embodiment, the electron source 2 is configured to supply the electron when the electron source 2 is in the off period. Therefore, the gas in the hermetically sealed vessel 1 is excited by the electron when in the off period. Consequently, even if the electron source is under the off period, the excitation of the ultraviolet is kept. Therefore, it is possible to obtain the lighting device with improvement of the light emission efficiency.

In addition, in this embodiment, the electron source 2 is realized by the Ballistic Electron Surface-Emitting type electron source. The Ballistic Electron Surface Emitting type electron source comprises the lower electrode 25, the surface electrode 27 disposed in an opposite relation to the lower electrode 25, and the strong electric field drift layer 26 which is interposed between the lower electrode 25 and the surface electrode 27. Therefore, the electron source 2 receives the forward bias voltage and the reverse bias voltage from the control unit 5. The reverse bias voltage has the electrical potential which is opposite to the electrical potential of the forward bias voltage. That is, the control unit 5 is configured to apply the forward bias voltage and the reverse bias voltage between the surface electrode 27 and the lower electrode 25. When the electron source 2 receives the forward bias voltage, the electron source 2 supplies the electron to the inside of the hermetically sealed vessel 1. When the electron source 2 receives the forward bias voltage, the electron is caught by the trap in the strong electric field drift layer 26. Subsequently, when the electron source receives the reverse bias voltage, the electron which is caught by the trap is emitted to the lower electrode. In this manner, the control unit 5 is configured to alternately give “the forward period for applying the forward bias voltage” and “the reverse period for applying the reverse bias voltage” to the electron source 2. Consequently, it is possible to prevent the loosening of the electrical field due to the electron which is caught by the trap. Therefore, it is possible to achieve the long operating life of the electron source 2.

In addition, in the lighting device of this embodiment, it is preferred to employ the control unit 5 being configured to apply the emission voltage between the anode electrode 3 and the electron source 2. In this case, the emission voltage has the rectangular wave. The emission voltage is in synchronization with the operation voltage having the rectangular wave. With this configuration, it is possible to obtain the lighting device which is configured to be operated by the low electrical power, compared with the lighting device being configured to apply constant voltage between the anode electrode 3 and the electron source 2.

In this case, it is preferred that the emission voltage of the rectangular wave is applied between the anode electrode 3 and the electron source 2 such that the electrical potential of the anode electrode 3 is higher than the electrical potential of the electron source 2. According to the above, it is preferred that the voltage value of the emission voltage in the on period is set to be higher than the voltage value of the emission voltage in the off period. Consequently, it is possible to operate the electron source 2 with low consumption of the electrical power. In addition, in the off period, it is possible to continuously move the electron toward the anode electrode 3.

It is noted that the hermetically sealed vessel 1 is filled with the xenon gas in this embodiment. However, the gas filled in the hermetically sealed vessel 1 is not limited to the xenon gas. That is, it is possible to employ helium gas, neon gas, argon gas, krypton gas, and nitrogen gas. In addition, it is also possible to employ the mixture of the aforementioned gases. In addition, the configurations are arbitrary combined.

1. A lighting device comprising:
a hermetically sealed vessel which has a light transmissive property;
a gas which is filled in said hermetically sealed vessel,
said gas being configured to emit a first light having wavelength when said gas is excited by electron,
the wavelength of the first light has a range from vacuum ultraviolet to visual light;
an electron source being disposed within said hermetically sealed vessel,
said electron source having a first operation electrode and a second operation electrode,
said electron source being configured to emit the electron when an operation voltage is applied between said first operation electrode and said second operation electrode;
an anode electrode being disposed within said hermetically sealed vessel, and being faced to said electron source;
a control unit being configured to apply the operation voltage between said first operation electrode and said second operation electrode,
said control unit being configured to apply an emission voltage between said electron source and said anode electrode such that said electron is moved toward said anode electrode;
a phosphor being disposed within said hermetically sealed vessel,
said phosphor being configured to emit a second light having wavelength which is different from the wavelength of the first light when said phosphor being excited by the first light; wherein
said electron source is configured to emit the electron having energy distribution when said electron source receives the emission voltage,
the energy distribution having a peak energy,
the peak energy is higher than an excitation energy of said gas, and
the peak energy is lower than an ionization energy of said gas.

2. The lighting device as set forth in claim 1, wherein
said gas is filled in said hermetically sealed vessel such that said gas has gas pressure of equal to or more than 2 kPa to equal to or less than 20 kPa.

3. The lighting device as set forth in claim 2, wherein
said gas is a noble gas, and is filled in said hermetically sealed vessel to have a predetermined gas pressure,
said predetermined gas pressure is set to form an excimer when said gas is excited.

4. The lighting device as set forth in claim 1, wherein
said control unit is configured to apply the operation voltage which is a rectangular wave to the electron source, whereby said control unit provides said electron source with an on-state and off-state alternately,
said electron source is configured to emit the electron over an on-period when said electron source has the on-state,
said electron source is configured to stop emitting the electron over an off-period when said electron source has the off-state.

5. The lighting device as set forth in claim 4, wherein
said gas has a property of making an afterglow over an afterglow period,
the afterglow period is started from a time when a state of said electron source is shifted from the on-state to the off-state,
the off-period is set to be shorter than the afterglow period.

6. The lighting device as set forth in claim 4, wherein
said electron source is a Ballistic Electron Surface-Emitting type electron source,
said Ballistic Electron Surface-Emitting type electron source comprises a lower electrode, a surface electrode, and a strong electric field drift layer,
said surface electrode is disposed in an opposed relation to said lower electrode,
said surface electrode defines said first operation electrode,
said lower electrode defines said second operation electrode,
said strong electric field drift layer is disposed between said surface electrode and said lower electrode,
said strong electric field drift layer comprises a plurality of semiconductor fine crystals and a plurality of electrically insulation layers,
said semiconductor fine crystals having sizes of nanometer orders,
each said electrically insulation layers is formed on a surface of said semiconductor fine crystal, and has a thickness which is smaller than a grain size of said semiconductor fine crystal,
said control device is configured to apply the operation voltage which is the rectangular wave voltage and which is alternating voltage to said electron source.

7. The lighting device as set forth in claim 4, wherein
said control unit is configured to apply said emission voltage which is a rectangular wave voltage between said anode electrode and said electron source,
said emission voltage is in synchronization with said operation voltage.

8. The lighting device as set forth in claim 7, wherein
said control unit is configured to apply the emission voltage between said anode electrode and said electron source such that said anode electrode has an electrical potential which is higher than an electrical potential of said electron source,
a voltage value of said emission voltage in the off-period is lower than the a voltage value of said emission voltage in the on-period.

9. The lighting device as set forth in claim 1, wherein
said electron source is spaced from said anode electrode by an interval, and the interval is set to be greater than a Paschen minimum.

10. The lighting device as set forth in claim 1, wherein
said gas is a gaseous xenon, and
said electron source is configured to emit the electron having the energy distribution which has a peak energy, and
the peak energy is equal to or higher than 8.44 eV and is equal to or lower than 12.13 eV.
